(19) United States
(12) Patent Application Publication
(10) Pub. No.: US 2021/0140126 A1
(43) Pub. Date: May 13, 2021

(54) FLUID SPRAY SYSTEM

(71) Applicant: Caterpillar Paving Products Inc., Brooklyn Park, MN (US)

(72) Inventors: Tyler Scott Burger, Plymouth, MN (US); Brian Daniel Nagel, Ramsey, MN (US)

(73) Assignee: Caterpillar Paving Products Inc., Brooklyn Park, MN (US)

(21) Appl. No.: 16/678,722

(22) Filed: Nov. 8, 2019

(51) Int. Cl. E01C 19/23; B05B 15/52; B05B 15/55; E01C 19/28; E01C 19/26

(52) U.S. Cl. CPC E01C 19/238; B05B 15/52; E01C 19/266; E01C 19/282; B05B 15/55

(57) ABSTRACT

A fluid spray system for a compaction machine is provided. The fluid spray system includes at least one nozzle adapted to deliver a flow of fluid adjacent to a compaction member. The fluid spray system includes a fluid pump adapted to provide the flow of fluid to the at least one nozzle. The fluid spray system includes an operator interface configured to generate a signal indicative of activating a test mode based on an operator input. The fluid spray system includes a controller configured to receive the signal from the operator interface. The controller is also configured to activate the fluid pump for a predefined time period to provide the flow of fluid to the at least one nozzle. The controller is further configured to deactivate the fluid pump based on elapsing of the predefined time period to limit the flow of fluid to the at least one nozzle.

### TECHNICAL FIELD

The present disclosure relates to a fluid spray system. More particularly, the present disclosure relates to the fluid spray system for a construction machine, such as a compaction machine.

### BACKGROUND

A compaction machine, such as a utility compactor or an asphalt compactor, includes a fluid spray system. The fluid spray system sprays a fluid on a compaction member, such as a compaction drum or a pneumatic roller of the compaction machine. The fluid may limit adhering of a compaction material on the compaction member, may provide a desired level of compaction of the compaction material, and so on. During operation, one or more nozzles of the fluid spray system may get clogged due to damage, deposition of dust, debris, and so on, on the nozzles. Accordingly, the nozzles may have to be frequently inspected in order to identify and service clogged nozzles.

In many situations, the nozzles may be inspected by moving the machine on ground and activating the fluid spray system in order to spray the fluid from the nozzles. Further, another person present on the ground may visually inspect the nozzles for any clogged nozzle(s) as the machine may move on the ground. Such an inspection method may require an operator to operate the machine on the ground and an additional person to walk around the machine to inspect the nozzles, in turn, increasing labor requirement and cost. Hence, there is a need for an improved fluid spray system for such applications.

U.S. Pat. No. 9,856,611 describes an apparatus for producing foamed bitumen for a road construction machine. The apparatus includes at least one mixing device having a reaction chamber. The reaction chamber is used to mix hot bitumen and at least one reaction fluid via an inlet device. The inlet device includes at least one inlet nozzle. A mixture of hot bitumen and the at least one reaction fluid is discharged from the mixing device via an outlet device. The mixing device also includes at least one compressed-air device using which the inlet device and/or the outlet device may be subjected to a compressed-air stream for testing and/or cleaning purposes.

### SUMMARY OF THE DISCLOSURE

In an aspect of the present disclosure, a fluid spray system for a compaction machine is provided. The fluid spray system includes at least one nozzle disposed adjacent to a compaction member. The at least one nozzle is adapted to deliver a flow of fluid adjacent to the compaction member. The fluid spray system includes a fluid pump fluidly coupled to the at least one nozzle. The fluid pump is adapted to provide the flow of fluid to the at least one nozzle. The fluid spray system also includes an operator interface configured to generate a signal indicative of activating a test mode based on an operator input. The fluid spray system further includes a controller communicably coupled to each of the fluid pump and the operator interface. The controller is configured to receive the signal from the operator interface. The controller is also configured to activate the fluid pump for a predefined time period to provide the flow of fluid to the at least one nozzle. The controller is further configured to deactivate the fluid pump based on elapsing of the predefined time period to limit the flow of fluid to the at least one nozzle.

In another aspect of the present disclosure, a compaction machine is provided. The compaction machine includes a frame and at least one compaction member rotatably mounted to the frame. The compaction machine also includes a fluid spray system provided in association with the at least one compaction member. The fluid spray system includes at least one nozzle disposed adjacent to the compaction member. The at least one nozzle is adapted to deliver a flow of fluid adjacent to the compaction member. The fluid spray system includes a fluid pump fluidly coupled to the at least one nozzle. The fluid pump is adapted to provide the flow of fluid to the at least one nozzle. The fluid spray system also includes an operator interface configured to generate a signal indicative of activating a test mode based on an operator input. The fluid spray system further includes a controller communicably coupled to each of the fluid pump and the operator interface. The controller is configured to receive the signal from the operator interface. The controller is also configured to activate the fluid pump for a predefined time period to provide the flow of fluid to the at least one nozzle. The controller is further configured to deactivate the fluid pump based on elapsing of the predefined time period to limit the flow of fluid to the at least one nozzle.

In yet another aspect of the present disclosure, a method for testing a fluid spray system associated with a compaction machine is provided. The method includes receiving a signal indicative of activating a test mode based on an operator input from an operator interface. The method also includes activating at least one of a fluid pump and a valve for a predefined time period to provide a flow of fluid to at least one nozzle by at least one of a controller and a timing unit. The method further includes deactivating at least one of the fluid pump and the valve based on elapsing of the predefined time period to limit the flow of fluid to the at least one nozzle by at least one of the controller and the timing unit.

Other features and aspects of this disclosure will be apparent from the following description and the accompanying drawings.

### BRIEF DESCRIPTION OF THE DRAWINGS

FIG. 1 is a perspective view of an exemplary compaction machine, according to one embodiment of the present disclosure;

FIG. 2 is a schematic representation of a fluid spray system for the compaction machine, according to one embodiment of the present disclosure;

FIG. 3 is a perspective view of an exemplary operator interface of the compaction machine, according to one embodiment of the present disclosure;

FIG. 4 is a schematic representation of another fluid spray system for the compaction machine, according to another embodiment of the present disclosure; and

FIG. 5 is a flowchart illustrating a method of working of the fluid spray system, according to one embodiment of the present disclosure.

### DETAILED DESCRIPTION

Wherever possible, the same reference numbers will be used throughout the drawings to refer to the same or like parts. Referring to FIG. 1, an exemplary compaction machine 100 is illustrated. The compaction machine 100 will be hereinafter interchangeably referred to as the “machine 100”. In the illustrated embodiment, the machine 100 is a utility compactor. Also, in the illustrated embodiment, the machine 100 is a dual drum type compaction machine. In other embodiments, the machine 100 may be any other compaction machine, such as an asphalt compactor. Also, the machine 100 may be a single drum type compaction machine, a multi drum type compaction machine, a vibratory type compaction machine, a non-vibratory type compaction machine, and so on, based on application requirements. The machine 100 may be associated with an industry, such as construction, mining, transportation, agriculture, waste management, and so on, based on application requirements.

The machine 100 includes a frame 102. The frame 102 defines a longitudinal axis X-X′ of the machine 100. The frame 102 supports one or more components of the machine 100. The machine 100 includes an enclosure 104 provided on the frame 102. The enclosure 104 encloses a power source (not shown) mounted on the frame 102. The power source may be any power source, such as an internal combustion engine, batteries, motor, and so on, or a combination thereof. The power source may provide power to the machine 100 for mobility and operational requirements.

The machine 100 also includes an operator cabin 106 mounted on the frame 102. The operator cabin 106 houses one or more controls (not shown) of the machine 100, such as a display unit, a touchscreen unit, a steering, an operator console, switches, levers, pedals, knobs, buttons, and so on. The controls are adapted to control the machine 100 on a work surface 108. Additionally, the machine 100 may include components and/or systems (not shown), such as a fuel delivery system, an air delivery system, a lubrication system, a propulsion system, a drivetrain, a drive control system, a machine control system, a ballast system, and so on, based on application requirements.

The machine 100 further includes at least one compaction member. In the illustrated embodiment, the machine 100 includes two compaction members, such as a first compaction member 110 and a second compaction member 112. The first compaction member 110 will be hereinafter interchangeably referred to as the “first member 110”. The second compaction member 112 will be hereinafter interchangeably referred to as the “second member 112”. Each of the first member 110 and the second member 112 is disposed spaced apart from one another along the longitudinal axis X-X′.

Each of the first member 110 and the second member 112 is rotatably mounted to the frame 102. Also, each of the first member 110 and the second member 112 is operably coupled to the power source. Each of the first member 110 and the second member 112 performs compaction of the work surface 108, such as a soil surface, an asphalt surface, and so on, based on application requirements. Each of the first member 110 and the second member 112 also supports and provides mobility to the machine 100 on the work surface 108.

In the illustrated embodiment, each of the first member 110 and the second member 112 is a smooth type compaction member. In other embodiments, one or more of the first member 110 and the second member 112 may be a set of pneumatic rollers, based on application requirements. In a situation when the machine 100 may be a single drum type compaction machine 100, the second member 112 may be omitted. In such a situation, the machine 100 may include one or more ground engaging members. The ground engaging members may be rotatably mounted to the frame 102 and disposed spaced apart from the first member 110 along the longitudinal axis X-X′. The ground engaging members may be any one of a set of wheels, pneumatic rollers, tracks, and so on, based on application requirements.

The present disclosure relates to a fluid spray system 200 for the machine 100. The fluid spray system 200 is provided in association with the at least one compaction member, such as the first member 110 and/or the second member 112. Referring to FIG. 2, a schematic representation of the fluid spray system 200 is illustrated. The fluid spray system 200 will be hereinafter interchangeably referred to as the “system 200”. The system 200 will now be explained with reference to the first member 110.

The system 200 includes at least one nozzle 202 (also shown in FIG. 1). In the illustrated embodiment, the system 200 includes four nozzles 202. In other embodiments, the system 200 may include single or multiple nozzles, based on application requirements. The nozzles 202 may be any fluid delivery nozzle, such as a flat fan type nozzle, a cone type nozzle, a jet type nozzle, a swirl type nozzle, a mist type nozzle, an atomizer type nozzle, a fixed type nozzle, a swivel type nozzle, an adjustable type nozzle, a combination thereof, and so on, based on application requirements. Each of the nozzles 202 is disposed adjacent to the first member 110. Accordingly, each of the nozzles 202 is adapted to deliver a flow of fluid adjacent to the first member 110, such as on an outer surface of the first member 110. The fluid may be any fluid, such as water, oil, an additive fluid, a water-based emulsion fluid, an additive type emulsion fluid, an oil-based emulsion fluid, and so on, based on application requirements.

The system 200 also includes a fluid pump 204. The fluid pump 204 is fluidly coupled to the at least one nozzle 202. The fluid pump 204 is adapted to provide the flow of fluid to each of the nozzles 202 from a reservoir (not shown). The fluid pump 204 may be any pumping device, such as a centrifugal type pump, a gear type pump, a piston type pump, and so on, based on application requirements. Additionally, in some embodiments, the fluid pump 204 may be an electronically controlled pump. In such a situation, the fluid pump 204 may include an Electronic Control Unit (ECU) (not shown).

The ECU may be adapted to control one or more parameters of the fluid pump 204, such as a mode of operation, operating pressure, flow rate, pump speed, and so on. In some embodiments, the fluid pump 204 may be an electrically controlled pump. In such a situation, the system 200 may include a switching unit 206 communicably coupled to the fluid pump 204. The switching unit 206 may be any electronic switch, such as a relay unit. Accordingly, the fluid pump 204 may be activated and deactivated based on an operating position of the switching unit 206.

The system 200 also includes an operator interface 208. The operator interface 208 is adapted to receive an operator input from an operator (not shown). Based on the operator input, the operator interface 208 is configured to generate a signal indicative of activating a test mode “T” of the system 200. Referring to FIG. 3, the operator interface 208 is illustrated. In the illustrated embodiment, the operator interface 208 is a rotating knob. In other embodiments, the operator interface 208 may be any operator input device, such as a button, a switch, a lever, a selectable option on a display device or a touchscreen unit, and so on, based on application requirements. As shown in the accompanying figure, the operator interface 208 is positioned in the test mode “T”. Accordingly, the operator interface 208 generates the signal indicative of activating the test mode “T”.

Referring to FIG. 2, the system 200 further includes a controller 210. The controller 210 may be any control unit configured to perform various functions of the system 200. In one embodiment, the controller 210 may be a dedicated control unit configured to perform functions related to the system 200. In another embodiment, the controller 210 may be a Machine Control Unit associated with the machine 100, an Engine Control Unit associated with the engine, and so on configured to perform functions related to the system 200. The controller 210 is communicably coupled to each of the fluid pump 204 and the operator interface 208.

Accordingly, the controller 210 is configured to receive the signal from the operator interface 208. Based on the received signal, the controller 210 is configured to activate the fluid pump 204 for a predefined time period to provide the flow of fluid to the at least one nozzle 202. The predefined time period may be any time period, such as 30 seconds (secs), 45 secs, 60 secs, and so on, based on application requirements. In one embodiment, the predefined time period may be stored in a database (not shown) communicably coupled to the controller 210. In another embodiment, the predefined time period may be stored in an internal memory (not shown) of the controller 210.

In some embodiments, the controller 210 may include a timing unit 212. More specifically, in some embodiments, the timing unit 212 may be a timer module embedded in the controller 210. As such, the predefined time period may be prestored in the timer module. In some embodiments, the controller 210 may be a dedicated, standalone timing unit 212, such as an electronic timer device. In such a situation, the predefined time period may be prestored in the electronic timer device. In yet some embodiments, the controller 210 may be a separate timer relay device.

In a situation when the fluid pump 204 may be the electronically controlled pump, the controller 210 may communicate (as shown by dashed line) with the ECU of the fluid pump 204 in order to activate the fluid pump 204 for the predefined time period. In a situation when the fluid pump 204 may be the electrically controlled pump, the controller 210 may activate the switching unit 206 in a closed position in order to activate the fluid pump 204 for the predefined time period.

Further, the controller 210 is configured to deactivate the fluid pump 204 based on elapsing of the predefined time period to limit the flow of fluid to the at least one nozzle 202. In a situation when the fluid pump 204 may be the electronically controlled pump, the controller 210 may communicate (as shown by dashed line) with the ECU of the fluid pump 204 in order to deactivate the fluid pump 204 based on elapsing of the predefined time period. In a situation when the fluid pump 204 may be the electrically controlled pump, the controller 210 may deactivate the switching unit 206 in an open position in order to deactivate the fluid pump 204 based on elapsing of the predefined time period.

Referring to FIG. 4, another embodiment of a fluid spray system 400 is illustrated. The system 400 will be hereinafter interchangeably referred to as the “system 400”. The system 400 includes components substantially similar to components of the system 200. As such, the system 400 includes the at least one nozzle 202, such as each of the nozzles 202. The system 400 includes the fluid pump 204 fluidly coupled to the at least one nozzle 202. The system 400 also includes the operator interface 208. Additionally, the system 400 includes a valve 402. The valve 402 is fluidly coupled to each of the at least one nozzle 202 and the fluid pump 204. Accordingly, the valve 402 may be any electronically controlled valve, such as a solenoid valve.

The system 400 further includes the controller 210 communicably coupled to the operator interface 208 and the valve 402. In some embodiments, the controller 210 may include the timing unit 212 as described with reference to FIG. 2. Accordingly, the controller 210 and/or the timing unit 212 is configured receive the signal from the operator interface 208. Based on the received signal, the controller 210 and/or the timing unit 212 is configured to activate the valve 402 for the predefined time period to provide the flow of fluid to the at least one nozzle 202 from the fluid pump 204. More specifically, the controller 210 and/or the timing unit 212 may activate the valve 402 in an open position. Accordingly, the flow of fluid may be provided to each of the nozzles 202 from the fluid pump 204 for the predefined time period.

Further, the controller 210 and/or the timing unit 212 is configured to deactivate the valve 402 based on elapsing of the predefined time period to limit the flow of fluid to the at least one nozzle 202 from the fluid pump 204. More specifically, the controller 210 and/or the timing unit 212 may deactivate the valve 402 in a closed position. Accordingly, the flow of fluid to each of the nozzles 202 from the fluid pump 204 may be limited based on elapsing of the predefined time period.

It should be noted that although the system 200, 400 is described herein with reference to the first member 110, in other embodiments, the system 200, 400 may be, additionally or alternatively, disposed in association with the second member 112, based on application requirements. It should also be noted that although the system 200, 400 is described herein with reference to the machine 100, in other embodiments, the system 200, 400 may be employed on any other construction machine, such as a paving machine, a mining machine, and so on, based on application requirements.

### INDUSTRIAL APPLICABILITY

The present disclosure also relates to a method 500 for testing the fluid spray system 200, 400 associated with the compaction machine 100. The fluid may be any fluid, such as water, oil, the additive fluid, the water-based emulsion fluid, the additive type emulsion fluid, the oil-based emulsion fluid, and so on, based on application requirements. Referring to FIG. 5, a flowchart of the method 500 is illustrated. At step 502, at least one of the controller 210 and the timing unit 212 receives the signal indicative of activating the test mode “T” based on the operator input. In the illustrated embodiment, the operator interface 208 is positioned in the test mode “T” by the operator in order to activate the test mode “T” of the system 200, 400. The timing unit 212 may be the timer module embedded in the controller 210, the dedicated electronic timer device, the separate timer relay device, and so on, based on application requirements.

At step 504, at least one of the controller 210 and the timing unit 212 activates at least one of the fluid pump 204 and the valve 402 for the predefined time period to provide the flow of fluid to the at least one nozzle 202. More specifically, referring to the system 200 described with reference to FIG. 2, the controller 210 and/or the timing unit 212 activates the fluid pump 204 for the predefined time period in order to provide the flow of fluid to each of the nozzles 202.

In some situations, the controller 210 and/or the timing unit 212 may activate the switching unit 206 in the closed position for the predefined time period. As such, the controller 210 and/or the timing unit 212 may activate the fluid pump 204 for the predefined time period in order to provide the flow of fluid to each of the nozzles 202. In another embodiment of the system 400 described with reference to FIG. 4, the controller 210 and/or the timing unit 212 activates the valve 402 in the open position for the predefined time period in order to provide the flow of fluid to each of the nozzles 202.

At step 506, at least one of the controller 210 and the timing unit 212 deactivates at least one of the fluid pump 204 and the valve 402 based on elapsing of the predefined time period to limit the flow of fluid to the at least one nozzle 202. More specifically, referring to the system 200 described with reference to FIG. 2, the controller 210 and/or the timing unit 212 deactivates the fluid pump 204 based on elapsing of the predefined time period in order to limit the flow of fluid to each of the nozzles 202.

In some situations, the controller 210 and/or the timing unit 212 may deactivate the switching unit 206 in the open position based on elapsing of the predefined time period. As such, the controller 210 and/or the timing unit 212 may deactivate the fluid pump 204 based on elapsing of the predefined time period to limit the flow of fluid to each of the nozzles 202. In another embodiment of the system 400 described with reference to FIG. 4, the controller 210 and/or the timing unit 212 deactivates the valve 402 in the closed position based on elapsing of the predefined time period to limit the flow of fluid to each of the nozzles 202.

It should be noted that although the method 500 is described herein with reference to the first member 110, in other embodiments, the method 500 may be, additionally or alternatively, disposed in association with the second member 112, based on application requirements. It should also be noted that although the method 500 is described herein with reference to the machine 100, in other embodiments, the method 500 may be employed on any other construction machine, such as a paving machine, a mining machine, and so on, having a fluid spray system.

The system 200, 400 and the method 500 provide a simple, effective, and cost-efficient method for testing the system 200, 400. The system 200, 400 may be activated in the test mode “T” in a neutral or stationary position of the machine 100. As such, the system 200, 400 may provide testing of the nozzles 202 of the system 200, 400 without moving the machine 100 on the work surface 108. Additionally, the operator of the machine 100 may activate the system 200, 400 and, thereafter, visually inspect the nozzles 202, in turn, eliminating need of an additional person to inspect the nozzles 202, reducing labor requirement, and reducing cost.

In some embodiments, the controller 210 and/or the timing unit 212 may be configured to activate the test mode “T” based on various operating parameters of the machine 100. The operating parameters of the machine 100 may include, but not limited to, switching the machine 100 in an on position or an off position, completion of a predefined number of operating hours of the machine 100 or the system 200, 400, activation of a diagnosis mode of the machine 100 or the system 200, 400, and so on. As such, the system 200, 400 may provide improved automation for the machine 100. The system 200, 400 employs easily or already available components on the machine 100, such as the controller 210 and/or the timing unit 212, the fluid pump 204, the switching unit 206, the valve 402, and so on, in turn, reducing complexity and costs. The system 200, 400 may be retrofitted on any compaction machine with limited or no modification to the existing system, in turn, providing flexibility and compatibility.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof

What is claimed is:

1. A fluid spray system for a compaction machine, the fluid spray system comprising:
at least one nozzle disposed adjacent to a compaction member, the at least one nozzle adapted to deliver a flow of fluid adjacent to the compaction member;
a fluid pump fluidly coupled to the at least one nozzle, the fluid pump adapted to provide the flow of fluid to the at least one nozzle;
an operator interface configured to generate a signal indicative of activating a test mode based on an operator input; and
a controller communicably coupled to each of the fluid pump and the operator interface, the controller configured to:
receive the signal from the operator interface;
activate the fluid pump for a predefined time period to provide the flow of fluid to the at least one nozzle; and
deactivate the fluid pump based on elapsing of the predefined time period to limit the flow of fluid to the at least one nozzle.

2. The fluid spray system of claim 1 further includes a switching unit communicably coupled to each of the fluid pump and the controller.

3. The fluid spray system of claim 2, wherein:
activating the fluid pump further includes activating the switching unit in a closed position, and
deactivating the fluid pump further includes deactivating the switching unit in an open position.

4. The fluid spray system of claim 2, wherein the switching unit is a relay unit.

5. The fluid spray system of claim 1, wherein the controller includes a timing unit.

6. The fluid spray system of claim 1 further includes a valve communicably coupled to the controller and fluidly coupled to each of the at least one nozzle and the fluid pump.

7. The fluid spray system of claim 6, wherein the controller is configured to:
receive the signal from the operator interface;
activate the valve for the predefined time period to provide the flow of fluid to the at least one nozzle from the fluid pump; and
deactivate the valve based on elapsing of the predefined time period to limit the flow of fluid to the at least one nozzle from the fluid pump.

8. The fluid spray system of claim 7, wherein:
activating the valve further includes activating the valve in an open position, and
deactivating the valve further includes deactivating the valve in a closed position.

9. A compaction machine comprising:
a frame;
at least one compaction member rotatably mounted to the frame; and
a fluid spray system provided in association with the at least one compaction member, the fluid spray system including:
at least one nozzle disposed adjacent to the compaction member, the at least one nozzle adapted to deliver a flow of fluid adjacent to the compaction member;
a fluid pump fluidly coupled to the at least one nozzle, the fluid pump adapted to provide the flow of fluid to the at least one nozzle;
an operator interface configured to generate a signal indicative of activating a test mode based on an operator input; and
a controller communicably coupled to each of the fluid pump and the operator interface, the controller configured to:
receive the signal from the operator interface;
activate the fluid pump for a predefined time period to provide the flow of fluid to the at least one nozzle; and
deactivate the fluid pump based on elapsing of the predefined time period to limit the flow of fluid to the at least one nozzle.

10. The compaction machine of claim 9 further includes a switching unit communicably coupled to each of the fluid pump and the controller.

11. The compaction machine of claim 10, wherein:
activating the fluid pump further includes activating the switching unit in a closed position, and
deactivating the fluid pump further includes deactivating the switching unit in an open position.

12. The compaction machine of claim 10, wherein the switching unit is a relay unit.

13. The compaction machine of claim 9, wherein the controller includes a timing unit.

14. The compaction machine of claim 9 further includes a valve communicably coupled to the controller and fluidly coupled to each of the at least one nozzle and the fluid pump.

15. The compaction machine of claim 14, wherein the controller is configured to:
receive the signal from the operator interface;
activate the valve for the predefined time period to provide the flow of fluid to the at least one nozzle from the fluid pump; and
deactivate the valve based on elapsing of the predefined time period to limit the flow of fluid to the at least one nozzle from the fluid pump.

16. The compaction machine of claim 15, wherein:
activating the valve further includes activating the valve in an open position, and
deactivating the valve further includes deactivating the valve in a closed position.

17. A method for testing a fluid spray system associated with a compaction machine, the method comprising:
receiving, from an operator interface, a signal indicative of activating a test mode based on an operator input;
activating, by at least one of a controller and a timing unit, at least one of a fluid pump and a valve for a predefined time period to provide a flow of fluid to at least one nozzle; and
deactivating, by at least one of the controller and the timing unit, at least one of the fluid pump and the valve based on elapsing of the predefined time period to limit the flow of fluid to the at least one nozzle.

18. The method of claim 17, wherein:
activating the fluid pump further includes activating a switching unit in a closed position, and
deactivating the fluid pump further includes deactivating a switching unit in an open position.

19. The method of claim 17, wherein:
activating the valve further includes activating the valve in an open position, and
deactivating the valve further includes deactivating the valve in a closed position.

20. The method of claim 17, wherein the fluid is one of water, an emulsion, and an additive.
